(19) United States
(12) Patent Application Publication
(10) Pub. No.: US 2011/0123285 A1
(43) Pub. Date: May 26, 2011

(54) MULTIAXIS MACHINING APPARATUS

(76) Inventors: Hiroyuki Matsuda, Kanagawa (JP); Shigeru Hosoe, Tokyo (JP)

(21) Appl. No.: 12/675,024

(22) PCT Filed: Aug. 12, 2008
(86) PCT No.: PCT/JP2008/064460

§ 371 Date: Feb. 24, 2010

(30) Foreign Application Priority Data
Aug. 27, 2007 (JP) 2007-220447

(51) Int. Cl. B23Q 1/25; B23D 5/00

(52) U.S. Cl. 409/313

(57) ABSTRACT

A tool retaining unit 20 includes a turntable 21c for retaining a cutting tool 2 so that the tip 2a of the cutting tool 2 is positioned on the extension of the rotation axis a of the tool retaining unit 20, and a turntable 22b for retaining the cutting tool 2 so that the tip 2a of the cutting tool 2 is positioned on the extension of a rotation axis b. As a result, the position of the tip 2a can be changed without the tip 2a of the cutting tool 2 being corrected in the direction of a cutting line.

### TECHNICAL FIELD

The present invention relates to a multiaxis machining apparatus and in particular to a multiaxis machining apparatus suitable for forming a free-form surface.

### PRIOR ART

There is a multiaxis machining apparatus having a workbench and a machining head, wherein the workbench can be rotated centering around a vertical axis and a horizontal axis, and the machining head moves a cutting tool facing a work in directions of three axis (Patent Document 1: Unexamined Japanese Patent Application Publication No. 2005-74568). Such multiaxis machining apparatus performs cutting work in a form of a line by moving the cutting tool forward and backward in a depth direction (for example, a X direction) while moving the cutting tools in a longitudinal direction (for example, Y direction) with respect to a cutting surface of the work, then the cutting tools is shifted relatively by one pitch in a lateral direction (for example, a Z direction) with respect to the cutting surface. By repeating the above operation, a discretionary curved surface can be formed on the work. In this case, it is disirable to change an attitude of the cutting tool so that a tip section of the cutting tool maintains an optimum cutting angle with respect to the cutting surface of the work.

Patent Document 1: Unexamined Japanese Patent Application Publication No. 2005-74568

### DISCLOSURE OF THE INVENTION

Incidentally, in the above multiaxis machining apparatus, if the workbench is rotated so that the tip section of the cutting tool maintains the optimum cutting angle, the tip section displaces from a cutting point. Thus in order to position the tip section of the cutting tool at the cutting point, operation to move the cutting tool in an opposite direction has to be carried out. The operation requires each mechanical elements to be operated, thus there is a possibility that the cutting accuracy is deteriorated. Also, compensation of the control system is required, which causes complication of the control system.

Thus, the present invention is to provide a multiaxis machining apparatus where the attitude of the tip section of the work tool such as the cutting tool can be changed and the compensation of the tip position is not necessary when the attitude of the cutting tool is changed, in other words a control system is simplified.

In order to resolve the above problems, the multiaxis machining apparatus of the present invention is provided with a) a tip position drive device to rotate the working tool centering around more than three rotation axes which intersect each other with the cutting tool being retained, and to maintain the tip section of the cutting tool at the intersection of more than three axes, and b) a position drive device to displace the cutting tools relatively with respect to a cutting object.

In the above multiaxis machining apparatus, since the position drive device displaces the cutting tool relatively with respect to the cutting object, a desirable free-form surface on the cutting object can be formed. When this occurs, since the tip position drive device rotates the cutting tool centering around three rotation axes which intersect at the tip section, the attitude of the tip section of tool can be changed discretionary, with the position of the tip section being maintained. Whereby, the cutting angle of the tip section of the cutting tool can be maintained without the position of the tip section being adjusted in accordance with adjustment of cutting angle of the tip section of the cutting tool.

In a specific embodiment of the present invention, the above multiaxis machining apparatus is characterized in that more than three rotation axes are orthogonal each other. In the above case, the cutting tool can be rotate centering around the three axes so as to direct the tip section of the cutting tool in a desirable direction.

Another embodiment of the present invention is characterized in that the tip position drive device rotates the cutting tool centering around the three axes within a rotation angle of 180°. In this case, the tip of the cutting tool is not rotated unnecessarily in the configuration.

Yet another embodiment of the present invention is characterized in that the axis of the cutting tool is disposed along one rotation axis amount three rotation axes. In the above case, attitude adjustment of the cutting tools based on the axis of the cutting tool is possible. Incidentally, the axis of the cutting tool means, in a front end section including the tip section of the cutting tools, an axis extending on a line segment connecting a tip with a center of an arc of a cutting edge which includes the tip. In case of a cutting tool having a sharp tip which does not form the arc section at the front end of the tip, the axis of the cutting tool is a bisector between a pair of edge lines extending from the front end to the rear end.

Further another embodiment is characterized in that with respect to at least one rotation axis which intersects with one of the above rotation axes on which the tip position drive device supports the axis of the cutting tool, the cutting tool is supported in a rotation manner in a double support state at a position where the axis of the cutting tool is interposed. In the above case, since the cutting tool is supported in the double support manner at an asymmetric position with respect to a force applied to the cutting tool, generation a moment can be suppressed with supporting rigidity being greatly enhanced.

Further, yet another embodiment is characterized in that, the tip position drive device is provided with a first supporting section to support the axis of the cutting tool centering around the first rotation axis representing one of the above-mentioned rotation axes, a second supporting section to support the first support section centering around a second rotation axis which intersects with the first rotation axis, a third supporting section to support the second supporting section centering around a third rotation axis which intersects with the first and the second rotation axes, wherein the second supporting section supports the first supporting section in a double supporting state at a position where the axis of the cutting tool is interposed. In the above case, only the second supporting section can be supported in the double supporting state which can prevent the third supporting section from increasing in size and acquire moving range of each rotation axis readily. Whereby, the tip position drive device can be made compact and light weight, and supporting rigidity and stability of the cutting tool are enhanced.

Further, yet another embodiment is characterized in that the rotation axis is supported by a static pressure bearing. In this case, since the cutting tool can be rotated smoothly with high accuracy, a highly accurate cutting can be realized, thus a highly accurate transfer optical surface and an optical surface such as the free-form curve can be created.

Further, yet another embodiment is characterized in that the static pressure bearing is a hydraulic static pressure bearing. The hydraulic static pressure bearing can enhance rigidity among the static pressure bearings and is superior in dumping characteristic. Thus the cutting tool can be rotated smoothly with high accuracy and high rigidity without shimmering despite of its compactness, and cutting work of a transfer optical surface having a large degree of freedom and high accuracy becomes possible. In particular, in case of multiaxis machining apparatus having an axis configuration where a plurality of axes are cumulated, it is desired to enhance rigidity of each axis and to accurately control action of each axis. In respect to the above objects, the hydraulic bearing is suitable compared to an air bearing.

### BRIEF DESCRIPTION OF THE DRAWINGS

FIG. 1 is a perspective view schematically showing a first embodiment of a multiaxis machining apparatus related to the present invention.

FIG. 2 is a control block diagram of a multiaxis machining apparatus related to the present invention.

FIG. 3 is an explanatory diagram showing change of attitude of a cutting tool of the multiaxis machining apparatus in FIG. 1 in a Y direction.

FIG. 4 is an explanatory diagram showing change of attitude of a cutting tool of the multiaxis machining apparatus in FIG. 1 in a X direction.

FIG. 5 is a perspective view showing an example of curve surface forming.

FIG. 6 is a perspective view describing an comparison example corresponding to FIG. 3.

FIG. 7 is a plane view showing a modified example of a multiaxis machining apparatus of FIG. 1.

FIG. 8 is a conceptual perspective view showing relevant portions of the multiaxis machining apparatus of the second embodiment.

FIG. 9 is a conceptual perspective view showing relevant portions of the multiaxis machining apparatus of the third embodiment.

### DESCRIPTION OF SYMBOLS

2 Cutting tool

2a Tip of the cutting tool

10 Work retaining section

11 Chuck

12 Elevation member

13 Elevation device

20 Tool retaining section

21 First tool rotation device

28a Chuck

21c Turntable

22 Second tool rotation device

22a Elevation member

22b Turntable

23 First stage device

24 Second stage device

28 Third tool rotation device

28a Chuck

30 Control device

31 Work position adjusting section

32 Tool angle adjusting section

61 Sensors

DP Cutting point

DS Cutting surface

M1 to M5 and M7 to M8 Rotation drive devices

RA Rotation axes

W Work

Wa Work surface

a, b and c Rotation axes

### DESCRIPTION OF THE PREFERRED EMBODIMENTS

### First Embodiment

A multiaxis machining apparatus related to a first embodiment of the present invention will be described with reference to the drawing.

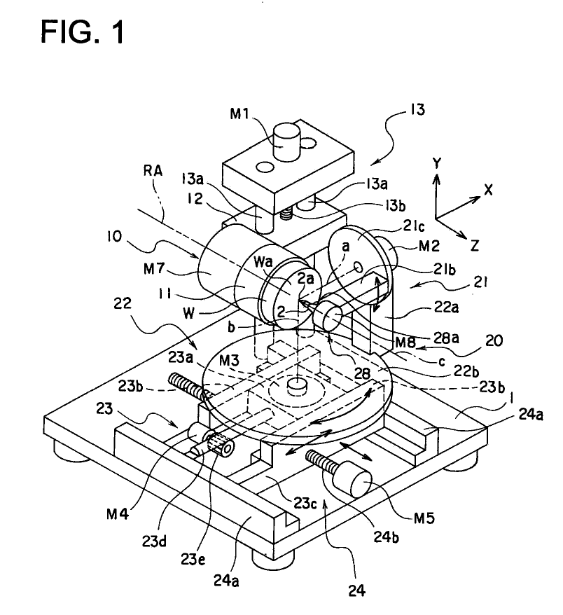

FIG. 1 is a perspective view schematically showing a multiaxis machining apparatus of the first embodiment.

As FIG. 1 shows, the Multiaxis machining apparatus is to create a cutting surfaces such as a molding surface of a metal mold to form an optical surface of an optical element such as a lens and a transfer optical surface by cutting work, having a work retaining section 10 and tool retaining section 20 on a base 1.

The work holding section 10, having a chuck 11 to hold a work W representing a cutting object and a motor, is provided with a rotation drive device M7 to support the chuck 11 rotatably centering around a rotation axis RA, an elevation member 12 to descend and ascend along with the rotation derive device M7 and the chuck 11, while supporting the rotation drive device M7, and an elevation drive device 13 to guide the elevation member 12 in the Y direction. Meanwhile, the rotation drive device M7 enables lathe turning of the work W.

The elevation drive device 13 is configured with a guide post 13a, standing on a base 1 to extend in the Y direction, inserted in an elevation member 12 in a sliding manner, a screw rod 13b, having an end section supported rotatably with the base 1, screwed with the elevation member 12, and a rotation drive device M1 to rotate the screw rod 13b in a clockwise and an anticlockwise directions.

In the elevation drive device 13, when the rotation drive device M1 is driven to rotate in one direction, the screw rod 13b rotate in one direction, accordingly, the elevation member 12 moves in the Y direction to negative or positive direction. Whereby, a work W fixed onto the elevation member 12 via the rotation drive device M7 and the chuck 11, moves in the Y direction to negative or positive direction. Here, the work W fixed on the chuck 11 is supported at a discretionary position centering around the rotation axis RA by operating the rotation drive device M7, or rotated at a desirable speed centering around the rotation axis RA.

Incidentally, the elevation drive device 13 can be a guide post, having a cross-section in a shape of a rectangular, penetrating a center section of the elevation member 12, instead of the guide post 13a in a shape of a circular cylinder. Also, in the elevation drive device 13, can be configured that instead of the screw rod 13b, a rod having a rack formed on the surface thereof is used, and a pinion is disposed at the elevation member 12 to mesh with the rack, the pinion is rotated in a clockwise or anticlockwise directions by a motor disposed at the elevation member 12. Also, it can be configured that installing a cylinder is installed on the base 1, and an end of a piston in the cylinder is connected with the elevation member 12.

The tool retaining section 20 is provided with a first tool rotation device 21, a second tool rotation device 22 and a third tool retaining section 28. The tool retaining sections 21, 22 and 28 represent tip position drive devices to adjust attitude of a tip 2a of a cutting tool 2. The first tool rotation device 21 rotates the tool 2 centering around the rotation axis a, the second tool rotation device 22 rotates the cutting tool 2 centering around the rotation axis b and the third tool rotation device 28 rotates the cutting tool 2 centering around the rotation axis c. The rotation axes a, b and c intersect orthogonally at one point. The intersection point of the rotation axes a, b, and c coincides with the tip 2a i.e. a front end of the cutting tools 2. Incidentally, the rotation axis b extends in parallel to the Y direction and the rotation axes a and c maintain a state where they intersect orthogonally within X and Z planes.

The first tool rotation device 21 supporting the cutting tool 2 via the third tool rotation device 28, is configured with an arm 21b to fix an front end of the third tool rotation device 28 at an front end thereof, a turntable 21c, supporting the arm 21b, disposed rotatable centering around the rotation axis a, and a rotate drive device M2 having a motor whose axis is connected with the axis of the turntable 21c to rotate the turntable 21c in the clockwise and the anticlockwise direction.

In the turntable 21c, a bearing enabling the turntable 21c to rotate smooth and accurate rotation is installed. The turntable 21c is disposed so that the extended line of the rotation axis a contacts with the tip 2a of the cutting tool 2 mounted on the chuck 28a. Also, the turntable 21c rotates in a range of rotation angle of ±90° with a position where the axis of the cutting tool 2 is horizontal as a center. Whereby, the tip 2a can be changed its attitude in a vertical direction within the range of 180° with a lower limit of 90° downward and an upper limit of 90° upward.

The bearing installed in the turntable 21c is, for example, a static pressure bearing such as a hydraulic static pressure bearing. With the above bearing, highly accurate and smooth rotation of the cutting tool 2 around the rotation axis a is realized. In particular, incase of the hydraulic static bearing, enhancement of rigidity can be facilitated and the turntable 21c can be downsized because of superior damping characteristic, and the cutting tool 2 can be smoothly rotated without simmering with high accuracy and high rigidity.

Incidentally, a rotation mechanism of the turntable 21c is not limited to the rotation drive device M2 described in the forgoing. For example, a rotation mechanism of the turntable can realized by disposing tooth on the circumference of the turntable 21c, disposing a pinion and a motor to drive the pinion at a support pillar 22a to be described, mashing the tooth of the pinion and the tooth of the turntable 21c and rotating the pinion through the motor.

The second tool rotation device 22 is configured with a support pillar 22a to support an upper section of the rotation drive device M2, a turntable 22b supporting the support pillar rotatable centering around a rotation axis b, and a rotation drive device M3 having a motor whose axis is directly connected with the axis of the turntable 22b to rotate the turntable 22b in clockwise and anticlockwise directions via the axis.

In the turntable 22b, there is disposed a bearing which enables the turntable to turn smoothly with high accuracy. The turntable 22b is disposed so that an extended line of the rotation axis b contacts with the tip 2a of the cutting tool 2 which is mounted on the chuck 28a. Also, the turntable 21c rotates in a range of rotation angle of ±90° with a state where the axis of the cutting tool 2 is within Y and Z planes as a center. Whereby, the tip 2a can change its attitude in a lateral direction within the range of 180°.

The bearing installed in the turntable 22b is, for example, a static pressure bearing such as a hydraulic static pressure bearing.

Incidentally, a rotation mechanism of the turntable 22b is not limited to the rotation drive device M3 described in the forgoing. For example, a rotation mechanism of the turntable can realized by disposing tooth on the circumference of the turntable 22b, disposing a pinion and a motor to drive the pinion at a frame body of the first stage device 23, meshing the tooth of the pinion with the tooth of the turntable 21c and rotating the pinion through the motor.

The third tool rotation device 28 is provided with a chuck 28 to mount the cutting tool 2 detachably, a rotation drive device M8, having a motor, to support the chuck 28a rotatably centering around the rotation axis c. The rotation drive device M8 is provided with a bearing which enables the chuck 28a to rotate smoothly with high accuracy. The chuck 28a is configured so that the attitude of the cutting tool 2 and the position of the tip 2a can be adjusted in a way that the rotation axis c can be adjusted to be parallel to the axis of the cutting tool 2. Incidentally, the cutting tool 2 fixed on the chuck 28a is retained at a discretionary rotation position centering around the rotation axis c by operating the rotation drive device M8. In the above case, the cutting tool 2 is not rotated unnecessarily. Namely, the rotation drive device M8 can rotate the cutting tool 2 in a rage of 180° centering around the axis of the cutting tool 2.

The bearing installed in the rotation device M8 is, for example, a static pressure bearing such as a hydraulic static pressure bearing.

Further, the tool retaining section 20 is provided with a first stage device 23 and a second stage device 24. The first stage device 23 moves the cutting tool 2 in a X direction via the turntable 22b, the support pillar 22a, the rotation drive device M2, the turntable 21c, the arm 21b, the rotation drive device M8 and the chuck 28a, and the second stage device 24 moves the cutting tool 2 in the Z direction via the turntable 22b and so forth.

The first stage device 23 is configured with a moving block 23a to retain the rotation drive device M3, a frame body 23c having the guide rail 23b to guide the moving block 23a in the X direction, a rack rod 23d disposed at an end surface of the moving block 23a extending in the X direction and a rotation drive device M4 disposed at the frame body 23c having a motor provided with a pinion 23a at an axis end capable of rotating in the clockwise and anticlockwise directions. In the guide rail 23b, a bearing to enable smooth and accurate sliding of the moving block 24a is installed. In the first stage device 23, the pinion 23e and the rack of the rack rod 23d are meshed. In the first stage device 23, when the rotation drive device M4 is driven, the pinion 23e rotates in one direction, thereby the rack rod 23d is moved in the x direction toward one direction and the moving block 23a moves in the X direction being guided by the guide rail 23b, as a result the turntable 22b is moved in the X direction.

Incidentally, the guide mechanism to guide the turntable 22b in the X direction in the first stage 23 can be configured in a way that one guide rail is disposed at the frame body 23c and the moving block 23a is disposed to straddle the guide rail. Also, instead of the rack rod, a screw rod can be disposed. The screw rod meshing with the moving block 23a is directly connected with the axis of the motor, and the motor drives the screw rod. Whereby, the moving block 23d can be moved. Also, a cylinder can be installed so as to move the moving block 23a by the cylinder, where an end of a piston rod in the cylinder is connected with the moving block 12a.

The second stage device 24 is configured with a guide rail 24a to guide the frame body 23c disposed on the base 1 in the Z direction, a screw rod 24b penetrating and being meshed with the frame body 23c, and a rotation drive device M5 to rotate the screw rod 24b in the clockwise and anticlockwise direction. In the guide rail 24a, a bearing to enable smooth and accurate movement of the frame body 23c is installed. In the second stage device 24, when the rotation drive device M5 is rotated in one direction, the screw rod 24b rotates in one direction, thereby the frame body 23c namely the moving block 23a and the turntable 22b moves in the Z direction.

Incidentally, in the second stage 24, the guide mechanism to guide the frame body 23c and the turntable 22b in the Z direction can be configured in a way that one guide rail is disposed at the base 1 and the frame body 23c is disposed to straddle the guide rail. Also, instead of the screw rod 24b, a rack rod can be disposed. The end section of the rack rod is connected with the frame body 23c rotatably and a pinion and a motor to rotate the pinion are disposed on the base 1. The pinion is rotated by the motor so that rack rod moves in the Z direction via the pinion. Whereby, the frame body 23c can move in the Z direction. Further, by disposing a cylinder on the base 1, and by connecting an end of a piston rod in the cylinder with the frame body 23c, the frame body 23c and the turntable 22b can be moved in the Z direction.

As described in the forgoing, the elevation drive device 13, the first stage device 23 and the second stage device 24 serve as position drive devices to displace the cutting tool 2 with respect to the work W relatively.

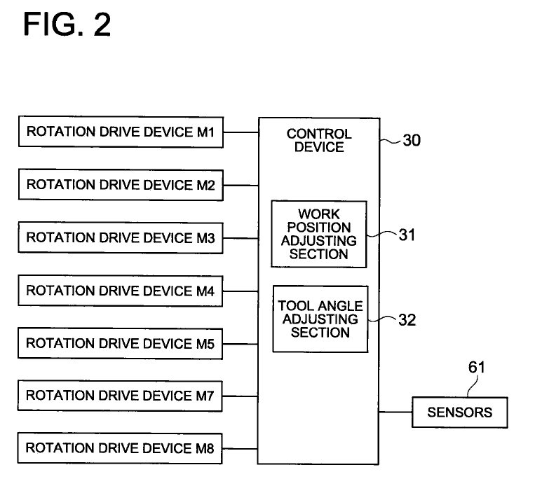

FIG. 2 is a block diagram explaining a control system of the multiaxis machining apparatus shown in FIG. 1, In the control system, a control device 30 is connected with the elevation drive device 13, the cutting tool retaining section 20, the rotation drive devices M1 to M5, M7 and M8 to operate the first and second stage devices 23 and 24, encoders to detect operation conditions of the rotation drive devices M1 to M5, M7 and M8 as well as angles and positions of the cutting tool 2 and sensors 61. Also, the control device 30 is provided with a work position adjusting section 31 and a tool angle adjusting section 32. The work position adjusting section 31 controls operation of elevation drive device 13, an the first and second stage devices 23 and 24 so as to enable positional adjustment of tip 2a of the cutting tool 2 with respect to the work W. Also, the tool angle adjusting section 32 controls operation of the tool retaining section 20 so as to adjust angles of the tip 2a of the cutting tool 2 three-dimensionally.

Specific cutting operation under control of the control device 30 in the multiaxis machining apparatus of the embodiment will be described as follow. In the multiaxis machining apparatus the work W is mounted on the chuck 11 of the work retaining section 10. The work position adjusting section 31 configuring the control device 30 sets the work so that the cutting surface Wa locates at a correct position. The cutting tool 2 is mounted on a chuck 28a of the tool retaining section 20. When this occurs, the cutting tool 2 is set at a position so that the tip 2a maintain a desirable angle with respect to cutting surface Wa at the cutting point in the work surface Wa of the work W through the tool angle adjusting section 32 configuring the control device 30, also performs setting so that the rotation axis a of the turntable 21c, the rotation axis b of the turntable 22b and the rotation axis c of the chuck 28a coincide at a point to be orthogonal.

By driving the rotation drive device Ml of the elevation drive device 13, the work W is moved in the Y direction, and by driving the rotation drive device M5 the tip 2a of the cutting tool 2 comes in contact with the work surface Wa of the work W and moved further by an desired cutting amount. Then the work W moves continuously in the Y direction (for example, upward) and the cutting tool 2 goes forward and backward continuously in the Z direction in accordance with a shape of the work surface Wa (for example a curve line) of the work W to be processed.

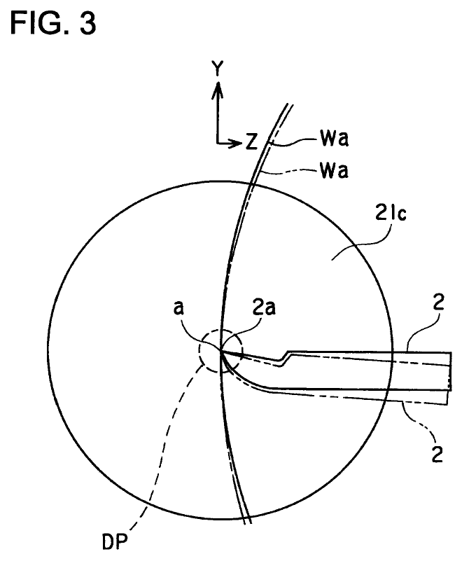

In the cutting operation, the attitude of the cutting tool 2 has to be changed so that the tip 2a of the cutting tool 2 maintain an optimum cutting angle with respect to, for example, the curve line along the Y direction within the work surface Wa of the work W. Change of the attitude of the cutting tool 2 is carried out by driving the rotation drive device M2 of the first tool rotation device 21 and the rotation drive device M3 of the second tool rotation device 22. When this occurs, the cutting angle is changed while the tip 2a of the cutting tool 2 remains at the same point without the tip 2a of the cutting tools 2 displacing in the Y direction since the tip 2a of the cutting tool 2 rotates centering around, for example, the rotation axis a as FIG. 3 shows. Namely, the angle of the tip 2a of the cutting tools 2 can be adjusted directly by the rotation drive device M2 and so forth, and an inclination of the tip 2a of the cutting tool 2 can be adjusted in a desirable condition with respect to the cutting surface at the cutting point DP.

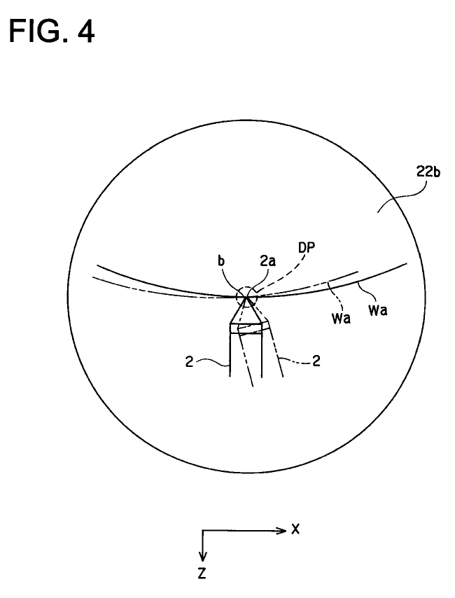

When the work surface Wa of the work W reaches at an upper most position, the frame body 23c move in the Z direction by the rotation drive device MS whereby the tip 2a of the cutting tool 2 detaches from the work surface Wa the work W. Subsequently, the elevation member 12 is moved in the Y direction downward through the rotation drive device Ml, then the work W returns so that the work surface Wa of the work W comes to a lower most position. At the almost the same time, the moving block 23a moves in the X direction by one pitch through the rotation drive device M4. When this occurs, if the work surface Wa of the work W curves within X and Y planes, the attitude of the cutting tools 2 has to be changed so that the tip 2a of the cutting tools 2 maintains an optimum angle with respect to the curve line of the work surface Wa of the work W. The change of the attitude of the cutting tool 2 is carried out by driving the rotation drive device M3 of the second tool rotation device 22 and the rotation drive device M8 of the third tool rotation device 28. When this occurs, the cutting angle is changed while the tip 2a of the cutting tool 2 remains at the same point without the tip 2a of the cutting tools 2 displacing in the X direction since the tip 2a of the cutting tool 2 rotates centering around, for example, the rotation axis b as FIG. 4 shows. Namely, the angle of the tip 2a of the cutting tools 2 can be adjusted directly by the rotation drive devices M2, M3 and M8, and the inclination of the tip 2a of the cutting tool 2 can be adjusted in a desirable condition with respect to the cutting surface at the cutting point DP.

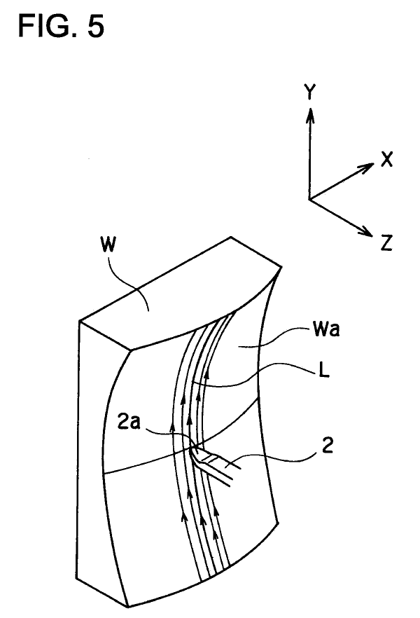

FIG. 5 is a perspective view showing an example of cutting operation by the multiaxis machining apparatus in FIG. 1. In this case, by moving the cutting tool 2 two-dimensionally with respect to the work surface Wa of the work W to form a toric surface, and the tip 2a of the cutting tool 2 can be maintained at the desirable angle (specifically for example vertical) with respect to the work surface Wa of the work W in each curve line L on the work surface Wa.

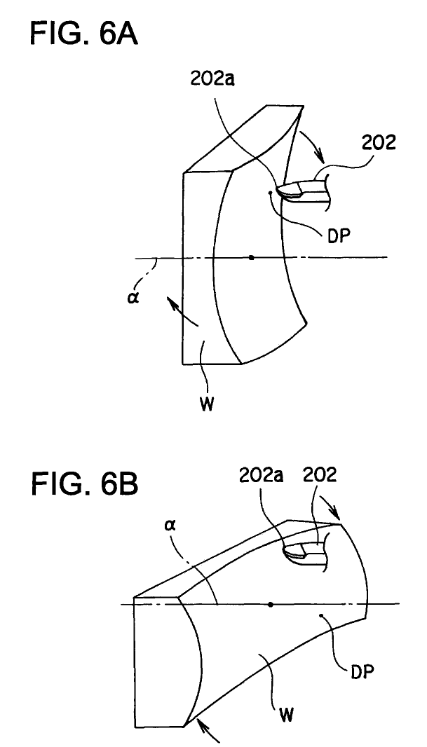

FIG. 6A and FIG. 6B are perspective views describing comparison examples corresponding to FIG. 3 and showing a cutting process by a conventional multiaxis machining apparatus, In cutting operation of the work W, it is preferable that tip 202a of the cutting tool 202 is in an optimum cutting angle. However, in the conventional multiaxis machining apparatus, for example, when the rotation attitude centering around the axis of the tip 202a is adjusted, a rotation mechanism of work W side is used. Specifically, for example, in case of the work W disposed as FIG. 6A shows, for example a disposition shown by FIG. 6B is realized by rotating the work W with an axis a as a rotation axis. However, when the work W rotated with the axis a of the work itself as the rotation axis, since the cutting point DP on the work W is also rotated centering around the axis a, the tip 202a is displaced from the cutting point DP. To solve the above displacing, positional correction was needed by relatively moving the cutting tool 202 in parallel using an unillustrated straight line. Such positional correction required operation of each mechanical element, which causes the control system to be complicated.

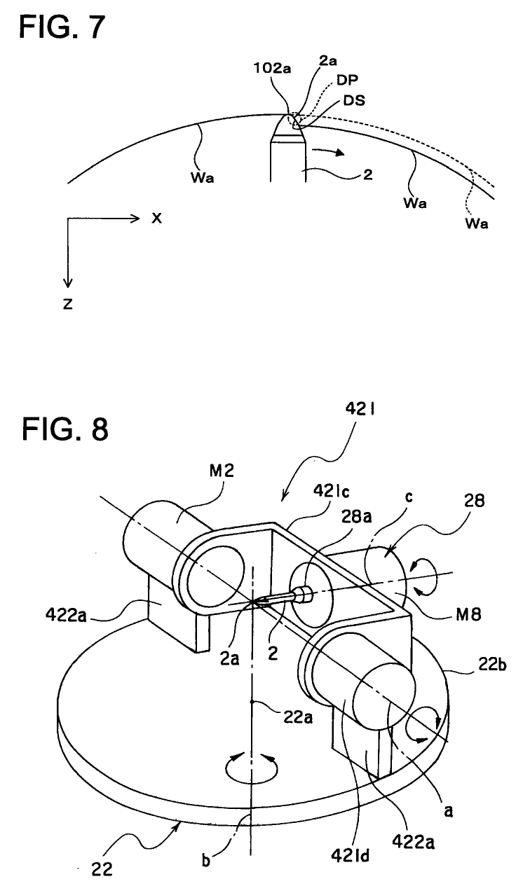

FIG. 7 is a schematic perspective view showing an exemplary modification of a multiaxis machining apparatus the related to the present invention. In this case, the cutting tool 2 performs a rather thick cutting in a lateral direction, namely the X direction. In the exaggerated figure, the tip 2a of the cutting tool 2 is a contact surface in contact with the cutting surface DS at the cutting point DP on the work surface Wa and not corresponding to the tip 102a. In this case, the angle of the tip 2a of the cutting tool 2 can be directly adjusted through the rotation drive devices M2, M3 and M8.

### Second Embodiment

A multiaxis machining apparatus of the second embodiment related to the present invention will be described with reference to the drawings as follow. Incidentally, since the second embodiment is a modified version of the multiaxis machining apparatus of the first embodiment, portions thereof not described are the same as that in the multiaxis machining apparatus of the first embodiment.

FIG. 8 is a perspective view showing relevant portions of the multiaxis machining apparatus of the second embodiment. A first tool rotation device 421 is configured with a movable member 421c in a shape of a channel, supporting the third tool rotation device 28, rotatable centering around a rotation axis a, a rotation drive device M2 having a motor whose axis is connected with the one end of an axis of the movable member 421c to rotate the movable member 421c in a clockwise and an anticlockwise directions via the axes, and a bearing section 421d to support the other end of the axis of the movable member 421c. The rotation drive device M2 and a bearing section 421d are fixed on a turntable 22b of the second tool rotation device 22 via the supporting members 422a. In the above case, the third tool rotation device 28 supports the axis of the cutting tool 2 centering around the rotation axis c as a first support member. Also, the first tool rotation device 421 supports the axis of the third tool rotation device 28 centering around the rotation axis a as a second support member. Further the second tool rotation device 22 supports the first tool rotation drive device 421 centering around the rotation axis b as a third support member. In the above configuration, only the first tool rotation device 421 support the cutting tool 2 in a double-support state which prevents the second tool rotation device 22 from increase in size and facilitates to acquire a movable range of each rotation axes a, b, and c. Incidentally, the second tool rotation device 22 and the third tool rotation device 28 have single support configurations, therefore, it facilitates light supporting mechanisms and makes acquiring the movable range relatively easy.

### Third Embodiment

A mult- of the third embodiment related to the present invention will be described with reference to the drawings as follow. Incidentally, since the third embodiment is a modified version of the multiaxis machining apparatus of the first embodiment, portions thereof not described are the same as that in the multiaxis machining apparatus of the first embodiment.

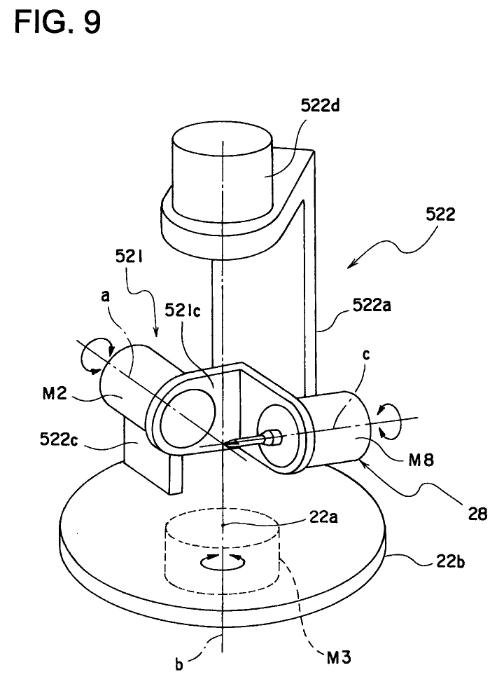

FIG. 9 is a perspective view showing relevant portions of the multiaxis machining apparatus of the third embodiment. A second tool rotation device 522 is configured with a turntable 22b to support a first tool rotation device 521, a support member 522a standing on the turntable 22b in a shape of a L character rotatable centering around the rotation axis along with the turntable 22b, a rotation drive device M3 having a motor, whose axis is directly connected with an end of an axis of the turntable 22b, to rotate the turntable 22b in a clockwise and an anticlockwise directions via the axis and a bearing section 522d to support the other end of the axes of the support member 522a. The first tool rotation device 521 is configured with a movable member 421c supporting the third tool rotation device 28, in a shape of a L character rotatable centering around the rotation axis a and a rotation drive device M2 having a motor, whose axis is directly connected with an end of an axis of the movable member 521c, to rotate the movable member 521c in a clockwise and anticlockwise directions via the axes. The rotation drive device M2 is fixed and supported on the turntable 22b of the second tool rotation device 522 via support member 522c. In the above case, the third tool rotation device 28 supports the axis of the cutting tool 2 centering around the rotation axis c as a first support member. Also, the first tool rotation device 521 supports the tool rotation device 28 centering around the rotation axis a as a second support member. Further, the second tool rotation device 522 supports the first tool rotation device 521 centering around the rotation axis b as a third support member. In the above case, only the second tool rotation device 522 supports the cutting tool 2 in the double-support state. Incidentally, the first tool rotation device 521 and the third tool rotation device 28 have the single-support configuration.

As above, the present invention has been described in line with the embodiments without the present invention being limited to the embodiments. For example, in the above embodiments, while the cutting tool 2 is moved in the X and Z directions, the work W can be moved in the X and Y directions. Also, in the above embodiments, while the work W is moved in the Y direction, the cutting tool can be moved in the Y direction.

Also, in the above embodiments, while the cutting tool 2 is an R bite having a round tip, a bite having a half circle shape and a bite having an apex can be mounted on the chuck 28a in accordance with cutting objects. The angle of the tips of the half circle bite and the apex bite with reference to the work surface Wa can be adjusted directly and precisely.

Also, in the above embodiments, the cutting tool 2 is described as a stationary tool. However, the cutting tool 2 can be a vibration cutting type tool. Namely, a vibration cutting unit to apply vibration to the cutting tools 2 is installed at the tool retaining section 20. In this case, while the tip 2a of the cutting tool 2 vibrates in a high frequency, the angle of the tip 2a with reference to the work surface Wa can be adjusted directly and precisely through the multiaxis machining apparatus in FIG. 1.

Also, in the above embodiments, while the angle of the tip 2a of the cutting tool 2 is rotated centering around the three rotation axes a, b and c through the rotation drive devices M2, M3 and M8, the cutting tool can be rotated centering around two axes among the rotation axes a, b and c. In this case, the angle of the tip 2a of the cutting tool 2 can be adjusted with some degree of freedom.

Also, in the above embodiments, while the rotation axes a and b are orthogonal with the axis of the cutting tool, the rotation axes a and b have not to be orthogonal with the axis of the cutting tool 2, thus the axes a and b can be in a non-orthogonal state.

1-8. (canceled)

9. A multiaxis machining apparatus, comprising:
a cutting tool tip position drive device to rotate a cutting tool centering around three of more rotation axes which intersect each other, while retaining the cutting tool and to position a tip of the cutting tool at an intersection point of the three or more rotation axes; and
a position drive device to relatively displace the cutting tool with respect to a cutting object.

10. The multiaxis machining apparatus of claim 9, wherein the three or more rotation axes intersect at the intersection point orthogonally.

11. The multiaxis machining apparatus of claim 10, wherein the cutting tool tip position drive device rotates the cutting tool centering around the three or more rotation axes within a rotation angle of 180°.

12. The multiaxis machining apparatus of claim 10, wherein an axis of the cutting tool is disposed along one of the three or more rotation axes.

13. The multiaxis machining apparatus of claim 12, wherein the cutting tool tip position drive device retains the cutting tool rotatably in a double-support state at a position to interpose the axis of the cutting tool in respect to at least one rotation axis intersecting with one axis which supports the axis of the cutting tool.

14. The multiaxis machining apparatus of claim 13, wherein the cutting tool tip position drive device comprises;
a first support section to support the axis of the cutting tool centering around a first rotation axis representing one rotation axis,
a second support section to support the first support section centering around a second rotation axis intersecting with the first rotation axis, and
a third support section to support the second support section centering around a third rotation axis intersecting with the first rotation axis and the second rotation axis,
wherein the second support section supports the first support section in the double-support state at a position to interpose the axis of the cutting tool.

15. The multiaxis machining apparatus of claim 9, wherein the rotation axis is supported by a static pressure bearing.

16. The multiaxis machining apparatus of claim 15, wherein the static pressure bearing is a hydraulic static pressure bearing.
